(19) United States
(12) Patent Application Publication
(10) Pub. No.: US 2006/0243656 A1
(43) Pub. Date: Nov. 2, 2006

(54) Filter apparatus having bendable filter

(75) Inventor: Hidetoshi Ooiwa, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/413,027

(22) Filed: Apr. 28, 2006

(30) Foreign Application Priority Data
May 2, 2005 (JP) 2005-134004

(51) Int. Cl. B01D 29/00

(52) U.S. Cl. 210/497.1

(57) ABSTRACT

A filter apparatus includes a tubular member that has an internal space. The filter apparatus further includes a filter that is accommodated in the internal space of the tubular member when the filter is bent around a straight imaginary line. The filter is adapted to filtering fluid flowing through the internal space of the tubular member. The filter has a cross section, which is perpendicular to the straight imaginary line, being in a substantially curvature protruding to an upstream with respect to a flow direction of the fluid when the filter is bent around the straight imaginary line. The filter has a first side and a second side that are opposite to each other with respect to the straight imaginary line. The tubular member has a first engage portion and a second engage portion. The first engage portion is adapted to engaging with the first side of the filter. The second engage portion is adapted to engaging with the second side of the filter.

### CROSS REFERENCE TO RELATED APPLICATIONS

This application is based on and incorporates herein by reference Japanese Patent Application No. 2005-134004 filed on May 2, 2005.

### FIELD OF THE INVENTION

The present invention relates to a filter apparatus having a bendable filter provided to a fluid passage.

### BACKGROUND OF THE INVENTION

Conventionally, a vapor fuel processing apparatus is provided to a vehicle such as an automobile. The vapor fuel processing apparatus includes a fuel tank, in which fluid such as vapor fuel is evaporated. The fluid is introduced into an air intake pipe through a canister and a solenoid valve, so that the vapor fuel processing apparatus restricts the fluid from being emitted to the atmosphere. The canister has a vent hole opening to the atmosphere, and accommodates an absorbent such as an activated charcoal. The absorbent may be disintegrated to be particles due to vibration of the engine. Foreign matters such as the particles of the absorbent and debris in the atmosphere may intrude into a valve device and an actuator of the solenoid valve. Consequently, sealing properties of the valve device between a valve plug and a valve seat may be degraded, and a movable device such as the valve plug and a movable core may cause a disorder.

According to U.S. Pat. No. 6,546,945 B2 (JP-A-2002-013659), a solenoid valve has a volume chamber accommodating a filter for protecting a valve portion therein from foreign matters. The volume chamber damps pulsation of fluid. Specifically, as shown in FIG. 6, a volume chamber 103 is formed midway through a fluid passage 102, through which fluid passes into a valve port 101. The volume chamber 103 accommodates a mesh filter 104. As shown in FIGS. 7A to 7C, the filter 104 includes a substantially rectangular frame 111 having a bridge portion 112. The filter 104 has two air passages 113 that communicate the upstream in the volume chamber 103 with the downstream in the volume chamber 103. The air passages 113 are provided with a mesh sheet 114. According to JP-A-11-137937, a frame 111 of the filter 104 is inserted along engaging grooves 107 of a filter accommodating chamber 106, which is formed integrally with the passage wall of the housing 105. In general, the frame 111 of the filter 104 is press-inserted into the engaging grooves 107, thereby substantially eliminating a gap between the frame 111 and the engaging grooves 107.

However, in this structure, the tip ends of the frame 111 needs chamfers 115 guided when being press-inserted. The end surfaces of the chamfers 115 and the bottom walls of the engaging grooves 107 and the sidewalls of the engaging grooves 107 form large gaps therebetween when the filter 104 is assembled to the filter accommodating chamber 106. In this structure, the filter 104 cannot capture microscopic foreign matters. The chamfers 115 may be omitted, and the frame 111 can be engaged with the engaging grooves 107. In this structure, the frame 111 and the engaging grooves 107 may define clearances. However, the frame 111 cannot be connected airtightly with the engaging grooves 107. In addition, the filter 104, which is assembled to the housing 105 as shown in FIG. 8A, is applied with fluid pressure shown by the arrow in FIG. 8B. In this condition, the filter 104 is bent toward the downstream of the fluid flow. As a result, the filter 104 may be detached from the engaging grooves 107. The frame 111 may be press-inserted to the engaging grooves 107. However, in this structure, the mesh sheet 114 may be broken when being press-inserted. The rigidity of the mesh sheet 114 may be enhanced by increasing the thickness of the frame 111 and the mesh sheet 114. However, in this structure, the filter 104 may be jumboized.

### SUMMARY OF THE INVENTION

The present invention addresses the above disadvantage. According to one aspect of the present invention, a filter apparatus includes a tubular member that has an internal space. The filter apparatus further includes a filter that is accommodated in the internal space of the tubular member when the filter is bent around a straight imaginary line, the filter being adapted to filtering fluid flowing through the internal space of the tubular member. The filter has a cross section, which is perpendicular to the straight imaginary line, being in a substantially curvature protruding to an upstream with respect to a flow direction of the fluid when the filter is bent around the straight imaginary line. The filter has a first side and a second side that are opposite to each other with respect to the straight imaginary line. The tubular member has a first engage portion and a second engage portion. The first engage portion is adapted to engaging with the first side of the filter. The second engage portion is adapted to engaging with the second side of the filter.

According to another aspect, a filter apparatus includes a tubular member that has an internal space having a first engage portion and a second engage portion. The filter apparatus further includes a filter that has a first side and a second side respectively engaging with the first engage portion and the second engage portion of the tubular member when the filter is accommodated in the internal space of the tubular member in a condition, in which the filter is resiliently bent around a straight imaginary line. The straight imaginary line is interposed between the first side and the second side of the filter. The filter is adapted to filtering fluid flowing through the internal space of the tubular member. The filter has a cross section, which is perpendicular to the straight imaginary line, being in a substantially curvature protruding to an upstream with respect to a flow direction of the fluid when the filter is bent around the straight imaginary line.

According to another aspect, a filter apparatus includes a tubular member that has an internal space having a first engage portion and a second engage portion. The filter apparatus further includes a filter that has a substantially rectangular shape having a first side and a second side, which are opposite to each other with respect to a straight imaginary line. The first side, the second side, and the straight imaginary line are substantially in parallel with each other. The first side and the second side resiliently engage respectively with the first engage portion and the second engage portion of the tubular member when the filter is accommodated in the internal space of the tubular member in a condition in which the filter is resiliently bent around the straight imaginary line. The filter has a cross section, which is perpendicular to the straight imaginary line, being in a substantially curvature protruding perpendicularly to the straight imaginary line when the filter is bent around the straight imaginary line.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic overview showing a fuel vapor processing apparatus according to an embodiment of the present invention;

FIG. 2 is a partially cross sectional side view showing a solenoid valve according to the embodiment;

FIG. 3A is a cross sectional view taken along the line IIIA-IIIA in FIG. 2, and FIG. 3B is a cross sectional view taken along the line IIIB-IIIB in FIG. 2, according to the embodiment;

FIG. 4 is a partially cross sectional view showing a filter of the solenoid valve, according to the embodiment;

FIG. 5 is a perspective view showing the filter, according to the embodiment;

FIG. 6 is a partially cross sectional side view showing a solenoid valve according to a prior art;

FIG. 7A is a top view showing a filter of the solenoid valve, FIG. 7B is a cross sectional view taken along the line VIIB-VIIB in FIG. 6, and FIG. 7C is an enlarged view showing the filter, according to the prior art; and

FIGS. 8A, 8B are partially cross sectional views showing the filter, according to the prior art.

### DETAILED DESCRIPTION OF PREFERRED EMBODIMENTS

(Embodiment)

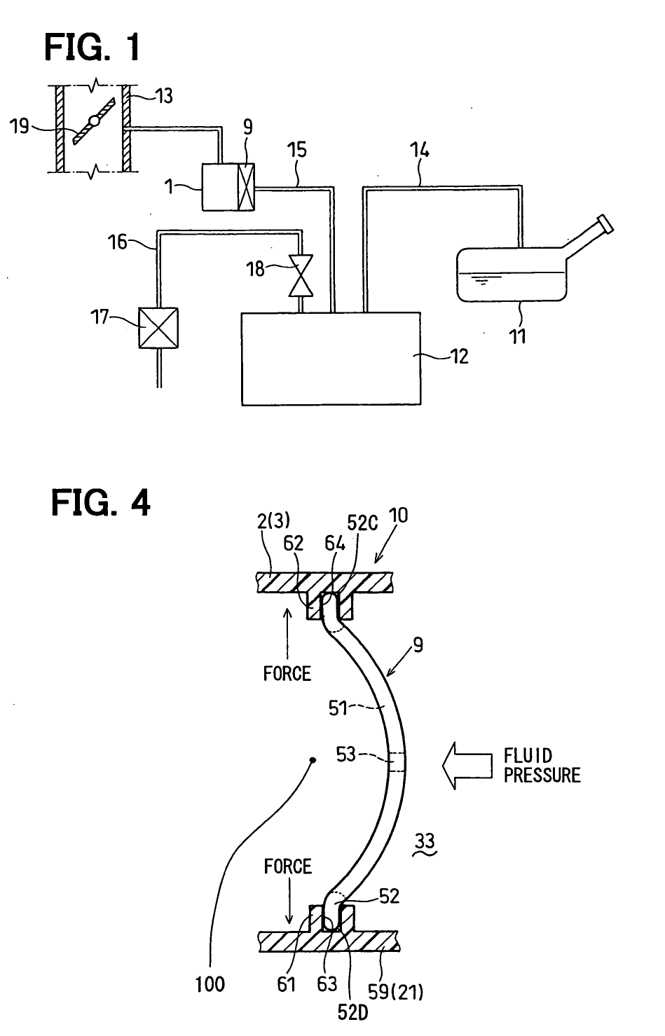

As shown in FIG. 1, a solenoid valve 1 is provided to a fuel vapor processing apparatus. Specifically, in this fuel vapor processing apparatus, fluid is introduced-into an intake pipe 13 of to an internal combustion engine such as a gasoline engine. The fluid is introduced through a canister 12 by utilizing negative pressure in the intake pipe 13, so that the fluid is purged. This fluid may be fuel vapor (evaporated gas) evaporated in a fuel tank of a vehicle such as an automobile, for example. The fluid can be restricted from being vent to the atmosphere by this purging operation. In the fuel vapor processing apparatus, the fuel tank 11 communicates with the canister 12 through a fluid introduction passage 14. The canister 12 communicates with the intake pipe 13 through a fluid introduction passage (purge line) 15.

The fuel tank 11 includes a pressure sensor (not shown) for detecting pressure in the fuel tank 11. The canister 12 accommodates an absorbent such as an activated charcoal for absorbing the fluid. The canister 12 has a vent hole (port) that connects with a vent pipe 16 opening to the atmosphere. The vent pipe 16 includes a filter 17 and a canister control valve 18. The canister control valve 18 is arranged midway through the vent pipe 16. The filter 17 filtrates air flowing into the canister 12. The canister control valve 18 is a normally opened solenoid valve that is adapted to blocking the vent hole of the canister 12, as appropriate. Air flows from an inlet of the vent hole that is connected to the vent pipe 16. The air passes through the filter 17. The filter 17 captures foreign matters contained in the air, thereby restricting the foreign matters from intruding into the intake pipe 13. The solenoid valve 1 accommodates a filter 9, so that a filter is omitted from the vent pipe 16.

The intake pipe 13 includes a throttle valve 19 for controlling an amount of air flowing into an intake passage communicating with combustion chambers of cylinders of the engine. The fluid introduction passage 15 includes the solenoid valve 1 midway thereof. The fluid introduction passage 15 connects with the downstream of the throttle valve 19 with respect to the flow direction of intake air. A leak check is performed in a following manner for detecting leakage of the fluid. First, the canister control valve 18 blocks the vent port of the canister 12. Subsequently, the solenoid valve 1 opens to apply negative pressure in the intake pipe 13 to both the fluid introduction passage 15 and the canister 12. Thereafter, the solenoid valve 1 is closed to completely blocking the fluid. Thus, it is evaluated whether pressure in the fuel tank 11 increases in accordance with a detection signal of the pressure sensor, after elapsing a predetermined time, so that the leak check is performed.

As follows, the structure, of the solenoid valve 1 is described. The solenoid valve 1 is arranged midway through the fluid introduction passage 15 of the fuel vapor processing apparatus. The solenoid valve 1 is a normally closed valve for electromagnetically controlling a purge amount of the fluid introduced from the canister 12 into the intake pipe 13. The solenoid valve 1 serves as a purge duty vacuum switching valve (VSV). The solenoid valve 1 is supplied with electricity via a solenoid operating circuit for a predetermined time controlled using an engine control unit (ECU), thereby controlling the purge amount of the fluid introduced from the canister 12 into the intake pipe 13. The ECU includes a microcomputer having a general structure, and controls a period, in which electricity is supplied to the solenoid valve 1. Specifically, the ECU controls a duty ratio, which is a ratio between an ON period, in which the solenoid valve 1 is supplied with electricity, and an OFF period, in which supplying electricity to the solenoid valve 1 is terminated. Thus, the ECU controls the purge amount, by which the fluid is introduced from the canister 12 into the intake pipe 13, using the solenoid valve 1.

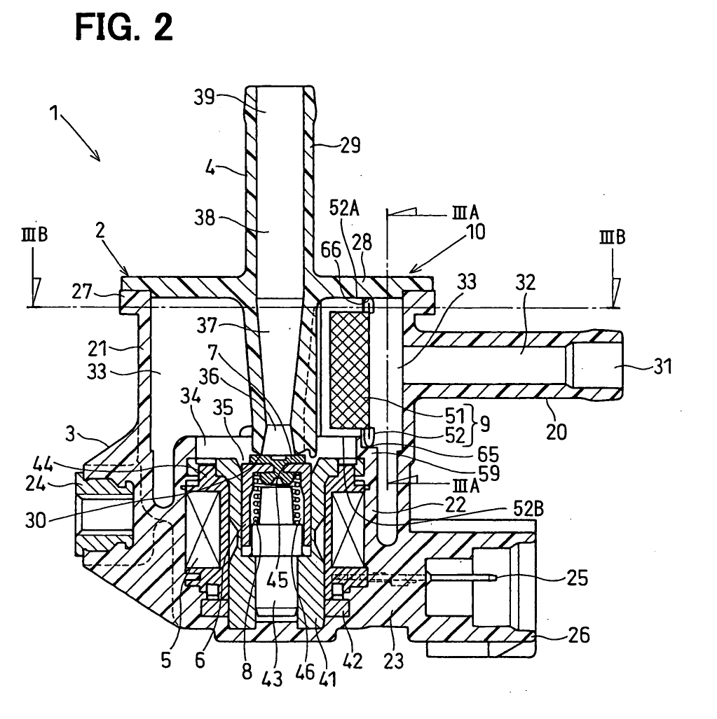

As referred to FIG. 2, the solenoid valve 1 includes a housing 2, a solenoid portion, a valve 7, and a coil spring 8.

The housing 2 is a substantially tubular member serving as a filter case. The housing 2 defines a fluid passage connecting through the midway of the fluid introduction passage 15. The solenoid portion serves as an electromagnetically operating device integrated with the housing 2. The valve 7 serves as a valve plug accommodated in the housing 2 such that the valve 7 is adapted to communicating and blocking the fluid passage defined in the housing 2. The coil spring 8 applies bias force (spring force) in a direction, in which the valve 7 is urged onto a valve seat.

The inner wall of the fluid passage defined in the housing 2 of the solenoid valve 1 has a filter holder (filter supporter) 10 that holds the filter 9 for capturing foreign matters contained in the fluid flowing to the valve port of the solenoid valve. The filter 9 has a substantially sheet shape, and is bendable.

The housing 2 includes a valve case 3 and a seat member 4. The housing 2 accommodates the valve 7 such that the valve 7 is adapted to communicating and blocking the fluid passage in the housing 2. The valve case 3 serves as a solenoid cover (first housing) that covers a coil assembly including the solenoid coil 5, thereby protecting the solenoid coil 5. The seat member 4 serves as a case cover (second housing), onto which the valve 7 is urged by the spring force of the coil spring 8. The housing 2 is formed of resin, for example. Specifically, the housing 2 may be formed of thermoplastic such as poly butylene terephthalate (PBT), poly phenylene sulfide (PPS), and polyamide (PA).

The valve case 3 includes a fluid pipe (inlet pipe) 20, a sidewall portion 21, and a tubular portion 22, which are integrally formed with reach other.

The fluid pipe (inlet pipe) 20 is in a substantially pipe shape. The fluid pipe 20 outwardly extends in a substantially radial direction, which is perpendicular to the center axis of the solenoid valve 1, i.e., perpendicular to the vertical direction in FIG. 2. The sidewall portion 21 is in a substantially tubular shape. The sidewall portion 21 and the seat member 4 define a fluid passage therebetween. The tubular portion 22 is provided to the radially inner side of the sidewall portion 21. The tubular portion 22 and the sidewall portion 21 are formed integrally with a resin mold portion 23, which is arranged on the lower side thereof in FIG. 2. The resin mold portion 23 covers the radially outer side of the solenoid portion. The outer circumferential periphery of the resin mold portion 23 is insert-molded with an insert nut 24. The solenoid valve 1 can be secured to an external device such as the canister 12 and the intake pipe 13 using a screw such as a bolt. The outer circumferential periphery of the resin mold portion 23 is formed integrally with a cylindrical connector shell (female connector) 26 that hold a pair of external connection terminals 25, via which the solenoid portion is supplied with electricity for energizing the solenoid. Tip ends of the terminals 25 are exposed into the connector shell 26, so that the terminals 25 serve as connector pins. The terminals 25 are inserted into a female connector of an external power supply or a solenoid operating circuit, thereby being electrically connected.

The seat member 4 is formed integrally with a substantially annular top plate portion 28 and a substantially cylindrical fluid pipe (outlet pipe) 29. The top plate portion 28 is welded to a connecting portion (flange portion) 27 of the sidewall portion 21 on the upper side thereof in FIG. 2. The top plate portion 28 may be screwed to or crimped to the sidewall portion 21. The fluid pipe 29 extends from the inner circumferential periphery of the top plate portion 28 along a substantially axial direction of the solenoid valve 1 in a substantially vertical direction in FIG. 2. The top plate portion 28 serves as a cover that blocks an opening 40 of the sidewall portion 21. The fluid pipe 29 is arranged substantially along the center axis of the solenoid valve 1. The sidewall portion 21 is eccentric with respect to the center axis of the solenoid valve 1. The sidewall portion 21 covers the outer circumferential periphery of the fluid pipe 29 on the lower side thereof in FIG. 2. The sidewall portion 21 and the fluid pipe 29 form a tubular space therebetween. As referred to FIGS. 1, 2, the fluid pipe 20 connects with the canister 12 through an upstream portion of the fluid introduction passage 15. The fluid pipe 20 has a fluid passage (canister side passage) 32 including an inlet port therein. This fluid pipe 20 is a substantially straight pipe.

The sidewall portion 21 has the inner circumferential periphery defining a passage wall surface. The tubular portion 22 has the outer circumferential periphery defining a passage wall surface. The top plate portion 28 has the top wall surface defining a passage wall surface. The fluid pipe 29 has the outer circumferential periphery defining a passage wall surface. The solenoid portion defines a passage wall surface. The passage wall surfaces of the sidewall portion 21, the tubular portion 22, the top plate portion 28, the fluid pipe 29, and the solenoid portion define a tubular space 33. This tubular space 33 serves as a volume chamber 33 that attenuates pulsation in pressure of the fluid flowing from the fluid passage 32. The volume chamber 33 (expanding portion) defines a fluid passage having a cross section, which is greater than the cross section of the fluid passage 32. The volume chamber 33 communicates with a valve chamber 35 through an annular space defined between the fluid passages of the fluid pipe 29 and the tubular portion 22. The valve chamber 35 is arranged on the radially inner side of the annular space 34. The valve chamber 35 is defined between the opening periphery of the fluid pipe 29 on the lower side in FIG. 2 and the wall surface of the passage in the solenoid portion.

The fluid pipe 29 has an open end of on the side of the solenoid portion arranged on the upstream side of the fluid flow. This open end of the fluid pipe 29 is formed integrally with a substantially annular valve seat 30, onto which the valve 7 can be seated. The inside of the valve seat 30 has a valve port 36 that is communicated and blocked by the valve 7. The fluid pipe 29 connects with the intake pipe 13 (FIG. 1) through the downstream of the fluid introduction passage 15. The inside of the fluid pipe 29 has fluid passage (intake pipe side passage) 37, 38 including an outlet port 39. The fluid passage 37 increases in inner diameter from the upstream to the downstream of fluid flow. The fluid passage 38 of the fluid pipe 29 on the side of the intake pipe is in a substantially straight pipe shape.

The solenoid portion is a solenoid actuator that generates magnetic attractive force (magnetomotive force) by being supplied with exciting current. The solenoid portion is constructed of a solenoid coil 5, a moving core (movable core) 6, fixed cores, and a piece 43. The solenoid coil 5 generates magnetic flux around the solenoid coil 5 by being supplied with electricity. The moving core 6 constructs a magnetic circuit with the solenoid coil 5 and the fixed cores. The fixed cores include a stator core 41, a yoke 42, and the like, which are excited by the solenoid coil 5. The piece 43 restricts the lift, in which movable members such as the moving core 6 and the valve 7 are axially movable.

The solenoid coil 5 is supplied with electricity, so that the solenoid coil 5 magnetizes magnetic members such as the moving core 6, a stator core 41, and a yoke 42, formed of magnetic materials, thereby driving the valve 7 and the moving core 6 in a valve open direction, in which the valve port 36 is opened. The solenoid coil 5 is constructed by winding a conductive wire around a coil bobbin 44 for a predetermined turns between a pair of collar portions. The conductive wire is provided with electrically insulative coating. The coil bobbin 44 is accommodated in a substantially cylindrical coil accommodating space defined between the resin mold portion 23 of the valve case 3 and the stator core 41. The solenoid coil 5 has a coil portion and a pair of lead wires (terminal wires). This coil portion is wound around the outer circumferential periphery of the coil bobbin 44. The lead wires are taken out of the coil portion. The radially outer periphery of the coil portion of the solenoid coil 5 is covered with the resin mold portion 23, so that the resin mold portion 23 serves as a resin case that protects the solenoid coil 5. The lead wires of the solenoid coil 5 are electrically connected with the pair of terminals 25, which electrically connects with the solenoid control circuit, for example. The lead wires of the solenoid coil 5 are electrically connected with the terminals 25 by crimping, welding, or the like.

The moving core 6 is formed of a magnetic material. The moving core 6 is in a substantially cup shape. The moving core 6 serves as an electromagnet. Specifically, the moving core 6 is magnetized by supplying electricity to the solenoid coil 5, thereby being attracted to an attractive portion of the stator core 41. The moving core 6 urges the valve 7 in a valve close direction, in which the valve 7 blocks the valve port 36, by spring force of the coil spring 8 when supplying electricity to the solenoid coil 5 is terminated. In this condition, the valve 7 is pressed onto the valve seat 30 of the fluid passage 29 of the seat member 4 in the valve close direction.

The moving core 6 has a substantially cylindrical sliding portion that is slidably supported in a cylindrical portion (expanding portion) of the stator core 41. The sliding portion of the moving core 6 has one open end and the other closed end. The sliding portion has a substantially disc-shaped block portion in the other end thereof. This disc-shaped block portion of the sliding portion has a through hole 45 that axially penetrates the block portion. The moving core 6 is slidably accommodated in the inner circumferential periphery of the cylindrical portion (expanded portion) of the stator core 41 in a condition, in which the moving core 6 engages with the outer circumferential periphery of the piece 43. The moving core 6 and the piece 43 define a substantially cylindrical space therebetween. This cylindrical space serves as a spring chamber 46 that accommodates the coil spring 8.

The stator core 41 is formed of a magnetic material to be in a substantially cylindrical shape. The stator core 41 serves as an electromagnet, which is magnetized by supplying electricity to the solenoid coil 5. The stator core 41 has an attractive portion midway through the cylindrical stator core 41. The cylindrical stator core 41 has the expanded portion, in which the inner diameter of the cylindrical stator core 41 increases, and a reduced portion, in which the inner diameter of the cylindrical stator core 41 decreases. The attractive portion is a step portion formed between the expanded portion and the reduced portion for axially attracting the axially one end of the moving core 6. In this embodiment, the fixed core is constructed of the stator core 41, the yoke 42, and the like. Alternatively, the fixed core may be constructed of only the stator core 41. The stator core 41 may be combined with one of a magnetic plate and a yoke 42 to construct the fixed core.

The piece 43 engages with the tubular portion defining the reduced portion of the stator core 41, so that the piece 43 is supported by the stator core 41. The piece 43 has a tip end surface on the upper side in FIG. 2. The tip end surface of the piece 43 serves as a restriction surface to restrict the lift, (movable distance) of the movable members on the axially one side. The movable members such as the moving core 6 and the valve 7 is latched on the tip end surface of the piece 43 at the full lift (maximum lift) thereof.

The valve 7 is a mold rubber (rubber valve, seal valve), which is formed of a rubber elastomer such as fluorocarbon rubber and silicone rubber. The valve 7 is assembled integrally with the moving core 6 of the solenoid portion. The valve 7 is formed on a block portion of the moving core 6 by molding, rubber printing, baking, or press-inserting. The valve portion 7 has a substantially annular rubber seal portion, a substantially annular rubber cushion, a rubber filled portion, and the like. The rubber seal portion is provided to the end surface of the block portion of the moving core 6 on the upper side in FIG. 2. The rubber seal portion serves as a valve seat portion, which is adapted to being seated onto the valve seat 30. The rubber cushion is provided to the end surface of the block portion of the moving core 6 on the lower side in FIG. 2. The rubber filled portion is provided to or filled in the through hole 45 of the block portion of the moving core 6. The valve 7 is axially slidable in the valve chamber 35, such that the valve 7 is adapted to reciprocating through the valve chamber 35. The rubber cushion of the valve 7 absorbs impact arising when the valve 7 makes contact with the restriction surface of the piece 43 and reduces sound arising in the moving core 6.

The coil spring 8 is accommodated in the spring chamber 46 defined between the moving core 6 and the piece 43. The coil spring 8 serves as a bias member that generates resiliency applied to the valve 7 in a direction, in which the valve 7 is urged onto the valve seat 30. The coil spring 8 has one axial end that is latched to a housing side hook of the piece 43. The coil spring 8 has the other axial end that is latched to a valve side hook of the moving core 6.

The ECU controls the period, in which the solenoid valve 1 is supplied with electricity, so that the opening area of the valve port 36 is changed in accordance with the lift of the valve 7 in the solenoid valve 1. Thus, the ECU controls a purge amount of the fluid flow introduced from the canister 12 into the intake pipe 13. When the period, in which the solenoid valve 1 is supplied with electricity, is long, an average amount of electricity supplied to the solenoid coil 5 becomes large, so that the moving core 6 approaches to the attractive portion of the stator core 41 against the resiliency of the coil spring 8. Thus, the lift of the valve 7 becomes large in conjunction with the movement of the moving core 6, so that the valve lift is set to be large. Thus, the purge amount increases.

When the period, in which the solenoid valve 1 is supplied with electricity, is short, an average amount of electricity supplied to the solenoid coil 5 becomes small, so that the moving core 6 is set back by the resiliency of the coil spring 8. Thus, the lift of the valve 7 becomes small in conjunction with the movement of the moving core 6, so that the valve lift is set to be small. Thus, the purge amount decreases. When supplying electricity to the solenoid valve 1 is terminated, the moving core 6 is returned to an initial position of the moving core 6 by spring force of the coil spring 8. In this condition, the valve 7 tightly makes contact with the valve seat 30 in conjunction with the movement of the moving core 6, thereby sealing the valve seat 30. Thus, the closed space constructed of the fluid introduction passages 14, 15 and the fuel tank 11 can be tightly blocked in the fuel vapor processing apparatus.

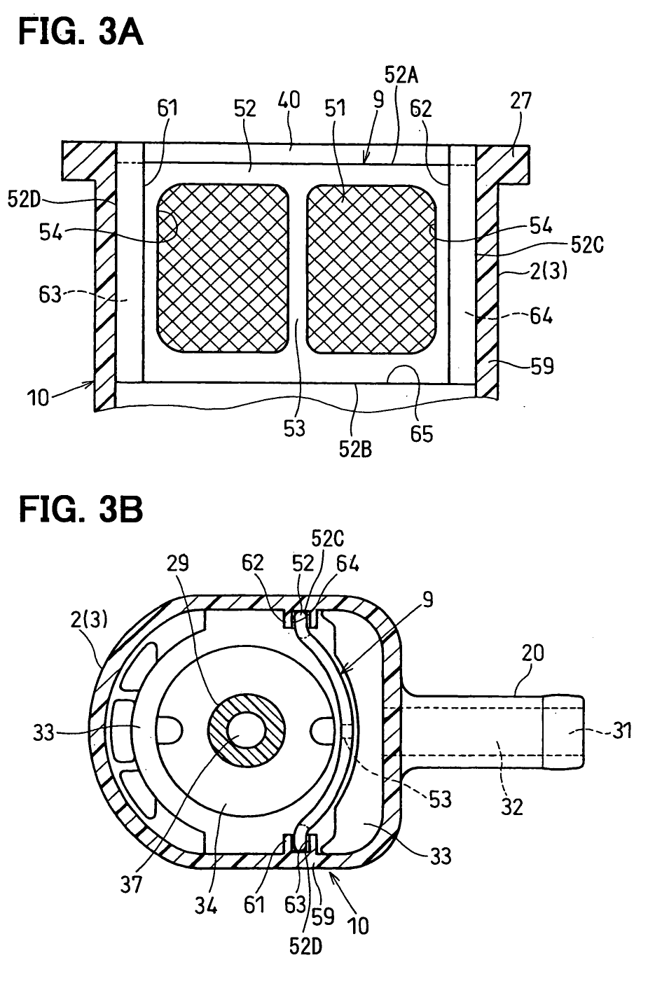

As shown in FIGS. 3, 4, the filter 9 is a sheet-like mesh filter such as a substantially plate shaped thin filter, for example. The filter 9 is resiliently bent when external force is applied to the filter 9 in a direction, in which the filter 9 is inserted. Specifically, the filter 9 is resiliently bent when force is applied to the filter 9 externally from both sides of the filter 9 with respect to the curved direction of the filter 9.

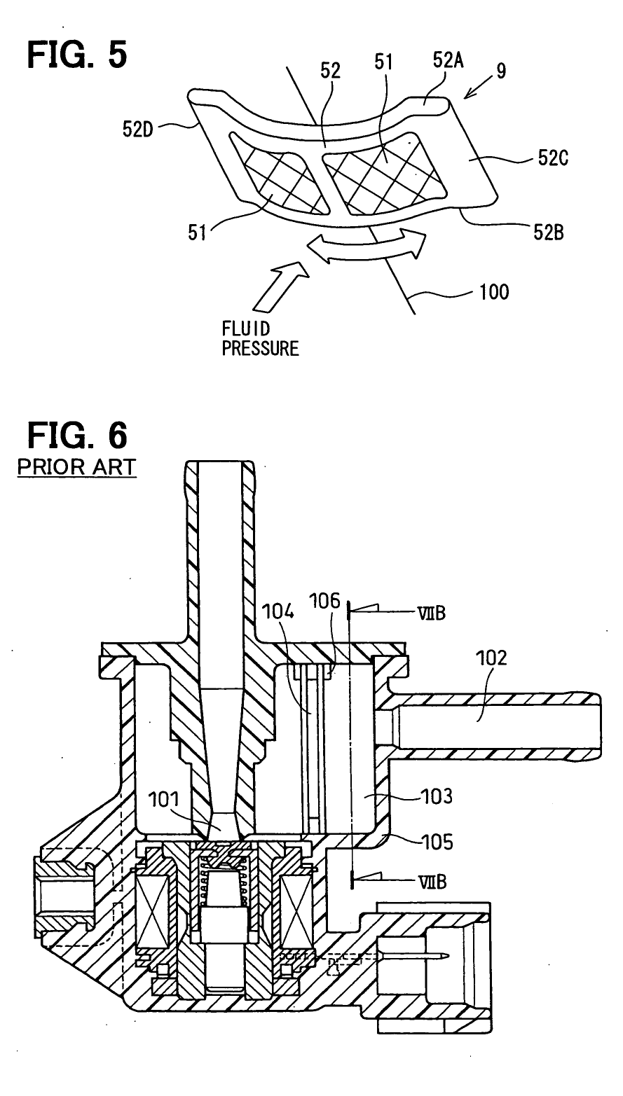

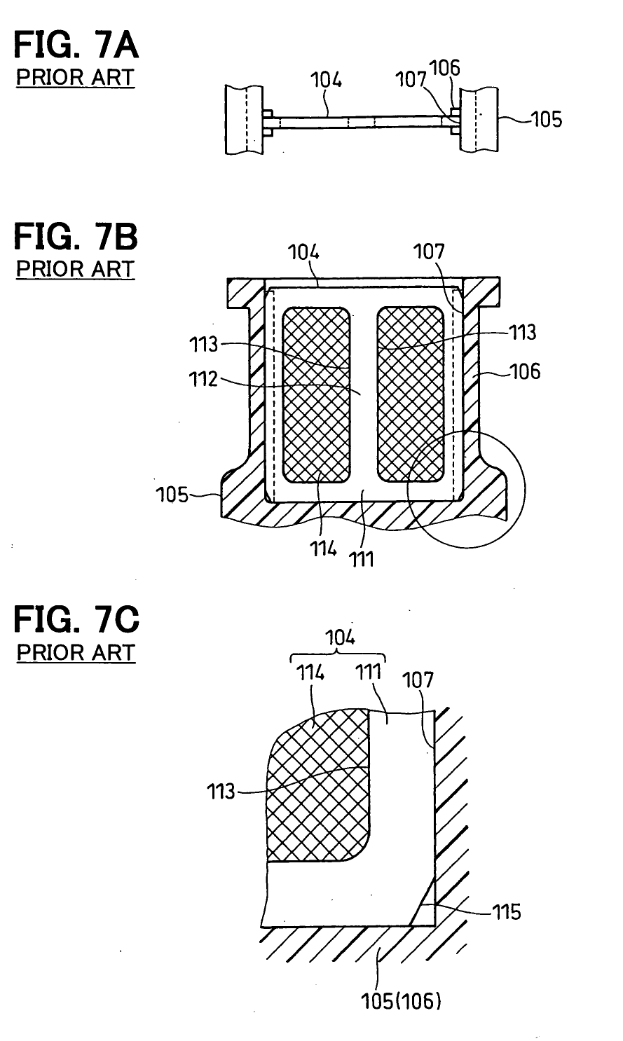

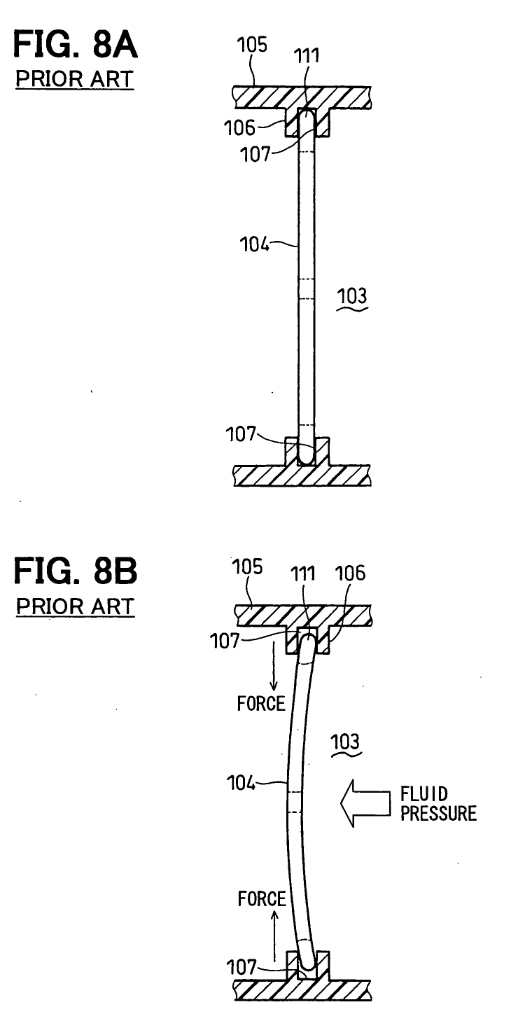

More specifically, as shown in FIG. 5, the filter 9 is bent around a straight imaginary line 100 by applying the external force. The filter 9 is accommodated in the internal space of the volume chamber 33 of the housing 2 of the solenoid valve 1. In this condition, the cross section of the filter 9 becomes to be in a bent shape being substantially convex (curvature) protruding to the upstream of the fluid flow. The cross section of the filter 9 is substantially perpendicular to the flow direction of fluid passing through the inside of the housing 2. The filter 9 includes a substantially square-shaped mesh sheet 51, a frame (filter frame) 52, and the like. The mesh sheet 51 filtrates the fluid. The filter frame 52 supports the outer periphery of the mesh sheet 51. The filter frame 52 engages with the housing 2, thereby being supported by the housing 2.

The filter 9 has a bent surface, which is bent vertically in FIG. 4. That is, the bent surface of the filter 9 is bent horizontally in FIG. 5. As shown in FIG. 5, the filter frame 52 has an upper side 52A and a lower side 52B (upper-lower sides 52A, 52B) in the upper end and the lower end of the filter frame 52 in FIG. 5. The bent surface of the filter 9 is bent around the straight imaginary line 100, which is substantially perpendicular to the pair of opposite upper-lower sides 52A, 52B of the filter frame 52. The filter frame 52 has a right side 52C and a left side 52D (right-left sides 52C, 52D) in the right end and the left end of the filter frame 52 in FIG. 5. The straight imaginary line 100 is substantially in parallel with the pair of opposite right-left sides 52C, 52D of the filter frame 52 in FIG. 5. The straight imaginary line 100 is interposed between the right-left sides 52C, 52D of the filter frame 52. That is, the right side 52C is opposite to the left side 52D with respect to the straight imaginary line 100.

As referred to FIGS. 2, 3A, the mesh sheet 51 is a filter element formed of a resinous material such as poly amide resin (PA). The mesh sheet 51 captures foreign matters contained in the fluid flowing to the side of movable components constructed of the moving core 6, the valve 7, and the like. The foreign matters may be particles of absorbent, which is supported in the canister 12, disintegrated due to vibration of the engine. The foreign matters may be debris in the atmosphere intruding into the fuel tank 11 when fuel is fed into the fuel tank 11. Alternatively, the foreign matters may be debris in the atmosphere intruding through a vent hole of the canister 12. The mesh sheet 51 is formed integrally with the filter frame 52 by insert-molding. The mesh sheet 51 may be formed of a plastic foam net or a metallic net.

The filter frame 52 is in a substantially square shape surrounded by four sides including two pairs of the opposite sides 52A, 52B, 52C, 62D. The filter frame 52 is formed of a resinous material such as polypropylene (PP). The filter frame 52 is in a bent curbed shape, which is bent to be in a substantially curvature, protruding to the upstream of the flow direction of the fluid. The filter frame 52 internally has multiple ports (windows) 54 partitioned by a bridge portion (horizontal sash bar, FIG. 3A) 53. The filter frame 52 has the right-left sides 52C, 52D, which are located on both ends with respect to the direction, in which the filter 9 is bent. The filter frame 52 has the upper-lower sides 52A, 52B, which are located on both ends perpendicularly to the direction, in which the filter 9 is bent. The bridge portion 53 connects the upper-lower sides 52A, 52B of the filter frame 52. The ports 54 are openings, through which fluid passes. The bent surface of the mesh sheet 51 is exposed through the ports 54.

As referred to FIG. 2, a volume chamber 33 is formed midway through the fluid passage communicating with the valve port 36 of the solenoid valve 1. The ports 54 (FIG. 3A) communicate the upstream of the volume chamber 33 with the downstream of the volume chamber 33. Each of the ports 54 has the corners, which are in a substantially arc shape. Alternatively, the corners of the ports 54 may be in a substantially square shape.

As shown in FIGS. 2, 4, the valve case 3 includes a recessed portion 59, which has the opposed surfaces and the bottom surface. The opposed surfaces define the wall surfaces of the sidewall portion 21. The bottom surface of the recessed portion 59 defines the upper end surface of the tubular portion 22. The seat member 4 includes the top plate portion 28. The top plate portion 28 and the recessed portion 59 of the valve case 3 define a filter accommodating space therebetween. The filter accommodating space is in a substantially rectangular shape. The filter accommodating space defines the fluid passage. The filter holder 10 is formed integrally with the valve case 3 and the seat member 4. In this structure, the filter holder 10 is a frame, which is in a substantially rectangular pipe shape. The filter holder 10 is defined by the wall surface of the sidewall portion 21 of the valve case 3, the wall surface of the tubular portion 22 of the valve case 3, and the wall surface of the top plate 28 of the seat member 4. The wall surface of the sidewall portion 21 is the opposed surfaces on both sides of the volume chamber 33. The wall surface of the tubular portion 22 is the bottom surface of the volume chamber 33. The wall surface of the top plate 28 is the top wall surface of the volume chamber 33.

The filter holder 10 is provided integrally with the partition wall, which is in a substantially rectangular pipe shape. When the filter holder 10 holds the filter 9, the filter 9 partitions the fluid passage into the upstream of the volume chamber 33 of the housing 2 and the downstream of the volume chamber 33. The upstream of the volume chamber 33 is on the side of the opening of the fluid passage 32. The downstream of the volume chamber 33 is on the side of the annular space. The filter holder 10 engages with the filter 9 such that the cross sectional shape of the filter 9 becomes a convex shape protruding to the upstream side of the flow direction of fluid.

As shown in FIG. 4, the filter holder 10 engages with the right-left sides 52C, 52D of the filter frame 52 of the filter 9. The right-left sides 52C, 52D of the filter frame 52 are protruded engaging portions. The filter holder 10 includes boss-shaped first and second engage portions 61, 62. Each of the first and second engage portions 61, 62 is a substantially boss shaped thick member protruding from the passage wall in the housing 2 into the fluid passage. Each of the first and second engage portions 61, 62 is in a substantially rectangular parallel piped member. The first and second engage portions 61, 62 are opposed to each other such that the first and second engage portions 61, 62 interpose the filter accommodating space therebetween.

The first engage portion 61 has a first engage groove (recessed groove) 63, which is in a substantially linear shape. The first engage groove 63 is substantially perpendicular to the flow direction of the fluid. The first engage portion 61 has a bottom surface, into which the left side 52D of the filter frame 52 of the filter 9 is inserted. In this structure, the bottom surface of the first engage portion 61 and the left side 52D of the filter frame 52 are sealed therebetween. The second engage portion 62 has a second engage groove (recessed groove) 64, which is in a substantially linear shape. The second engage groove 64 is substantially perpendicular to the flow direction of the fluid. The second engage portion 62 has a bottom surface, into which the right side 52C of the filter frame 52 of the filter 9 is inserted. In this structure, the bottom surface of the second engage portion 62 and the right side 52C of the filter frame 52 are sealed therebetween.

As referred to FIG. 2, the sidewall portion 21 of the valve case 3 has the wall portion defining the passage wall, which defines the volume chamber 33. The pair of the first and second engage portions 61, 62 protrudes from the passage wall of the sidewall portion 21 into the fluid passage on the side of the volume chamber 33. The left side 52D and the right side 52C of the filter frame 52 are slidably inserted into the first and second engage grooves 63, 64, thereby being supported by the first and second engage grooves 63, 64. Each of the first and second engage grooves 63, 64 has the width, which is slightly greater than the thickness of the left side 52D and the right side 52C of the filter frame 52. Specifically, the width or each of the first and second engage grooves 63, 64 is set such that the left side 52D and the right side 52C of the filter frame 52 is not press-inserted into the corresponding first and second engage grooves 63, 64. Alternatively, the width of each of the first and second engage grooves 63, 64 is set such that the left side 52D and the right side 52C of the filter frame 52 fit to the first and second engage grooves 63, 64 with a clearance.

As referred to FIGS. 2, 3A, the bottom surface defined by the recessed portion 59 of the valve case 3, i.e., the upper end surface of the tubular portion 22 on the upper side in FIG. 2 and the top wall surface of the top plate portion 28 of the seat member 4 interpose the upper-lower sides 52A, 52B of the filter frame 52 therebetween. In this structure, the filter holder 10 supports the filter 9 such that the cross sectional shape of the filter 9 is in the bent convex shape protruding to the upstream of the flow direction. The bottom surface defined by the recessed portion 59 of the valve case 3 has a first filter seat surface 65 (FIG. 3A). The first filter seat surface 65 directly makes contact with the lower side 52B of the filter frame 52, so that the first filter seat surface 65 and the lower side 52B seal therebetween. The first filter seat surface 65 serves as a load receiving portion receiving load from the lower side 52B of the filter frame 52 of the filter 9.

The top surface of the top plate portion 28 of the seat member 4 has a second filter seat surface 66 (FIG. 2). The second filter seat surface 66 directly makes contact with the upper side 52A of the filter frame 52, so that the second filter seat surface 66 and the upper side 52A seal therebetween. The second filter seat surface 66 serves as a load applying portion applying load to the upper side 52A of the filter frame 52 of the filter 9 in a direction, in which the lower side 52B of the filter frame 52 is urged onto the first filter seat surface 65 on the lower side in FIG. 2. This direction corresponds to the direction, in which the seat member 4 is assembled to the valve case 3. As referred to FIG. 2, a thick portion (boss-shaped portion) having the second filter seat surface 66 is protruded from the end surface of the top plate portion 28 of the seat member 4 to the side of the filter 9 on the lower side in the FIG. 2. The filter 9 connects with this end surface of the top plate portion 28 of the seat member 4, so that the top plate portion 28 of the seat member 4 air-tightly connects with the end surface of the flange portion 27 of the sidewall portion 21 of the valve case 3.

As follows, an example of an assembling process of the filter 9 into the solenoid valve 1 is described.

The valve case 3 is integrally formed of resin to be in the product shape thereof. As referred to FIG. 3A, the filter holder 10 is formed in the sidewall portion 21 and the tubular portion 22 of the valve case 3. The filter holder 10 is in a substantially U-shape opening on the upper side in FIG. 3A. The filter holder 10 has the pair of first and second engage grooves 63, 64, and the first filter seat surface 65. The seat member 4 is integrally formed of resin to be in the product shape thereof. The top plate portion 28 of the seat member 4 has the second filter seat surface 66 of the filter holder 10. The second filter seat surface 66 is in a substantially straight shape. The filter 9 is formed to be the product shape.

The filter holder 10 of the valve case 3 includes the first and second engage grooves 63, 64, to which the left side 52D and the right side 52C of the filter frame 52 are engaged. In this condition, specifically, the left side 52D and the right side 52C may be pressed by fingers of a manufacturing worker. The filter 9 is inserted into the filter holder 10 through the opening 40 of the sidewall portion 21 of the valve case 3, while the filter 9 is maintained being pressed and bent. The left side 52D and the right side 52C of the filter frame 52 are respectively inserted into the first and second engage grooves 63, 64, and subsequently, the pressing force is released, i.e., the filter frame 52 is released from fingers of the manufacturing worker. Thus, the shape of the filter 9 recovers by the resiliency thereof, so that the filter frame 52 of the filter 9 expands in the bent direction, along which the filter is bent. The left side 52D and the right side 52C of the filter frame 52 of the filter 9 make contact tightly with the bottom surface of the first and second engage grooves 63, 64. In this condition, the gaps formed between the left side 52D and the right side 52C of the filter frame 52 and the corresponding first and second engage grooves 63, 64 are eliminated.

Subsequently, the filter 9 is inserted to the bottom end of the first filter seat surface 65 of the tubular portion 22 of the valve case 3 along the first and second engage grooves 63, 64 in the condition, in which the left side 52D and the right side 52C of the filter frame 52 of the filter 9 engage with the first and second engage grooves 63, 64. The bottom end of the first filter seat surface 65 is on the lower side in FIG. 3A with respect to the opening 40. The lower side 52B of the filter frame 52 is abutted to the first filter seat surface 65 of the tubular portion 22 of the valve case 3. Thus, the assembling work of the filter 9 to the valve case 3 is completed.

Subsequently, the top plate portion 28 of the seat member 4 is mounted to the flange portion 27 of the sidewall portion 21 of the valve case 3 from the upper side in FIG. 2 with respect to the opening 40, so that the upper side of the filter frame 52 is pressed using the second filter seat surface 66 of the top plate portion 28 of the seat member 4. Thus, the lower side of the filter frame 52 is pressed onto the first filter seat surface 65 of the tubular portion 22 of the valve case 3. In this structure, the filter frame 52 is interposed between the second filter seat surface 66 of the seat member 4 and the first filter seat surface 65 of the valve case 3. Thus, the first and second filter seat surfaces 65, 66 make contact closely with the lower side 52B and the upper side 52A of the filter frame 52. In this condition, the gap between the first filter seat surface 65 and the lower side 52B of the filter frame 52 can be eliminated. In addition, the gap between the second filter seat surface 66 and the upper side 52A of the filter frame 52 can be also eliminated. Thus, the assembling work of the filter 9 to the housing 2 completes simultaneously with mounting the seat member 4 to the valve case 3. In this situation, as referred to FIG. 3B, the filter 9 is positioned, such that the convex bent surface of the filter 9 receives the fluid. That is, the filter 9 is mounted to the inside of the volume chamber 33 of the solenoid valve 1 such that the cross section of the filter 9 is convexly bent to the upstream side of the fluid flow.

The end surface of the flange portion 27 of the sidewall portion 21 of the valve case 3 may be welded using a welding method such as laser welding with the end surface of the top plate portion 28 of the seat member 4, so that the opposed end surfaces of the flange portion 27 and the top plate portion 28 may be sealed. In this structure, the end surface of the top plate portion 28 is preferably pressed onto the end surface of the flange portion 27 using a jig, and the entire circumference of the end surfaces may be welded. The jig serves as a bias unit that vertically presses the lower side 52B and the upper side 52A of the filter frame 52 in the direction in which the filter 9 is sandwiched between the first and second filter seat surfaces 65, 66.

Next, an operation of the solenoid valve 1 is described in reference to FIGS. 1 to 5.

The ECU supplies electricity to the solenoid coil 5 via an operating circuit, so that the solenoid coil 5 generates magnetic flux around the solenoid coil 5. Thus, this magnetic flux passes through the stator core 41, the yoke 42, and the moving core 6. In this operation, the stator core 41, the yoke 42, and the moving core 6 are magnetized, so that the moving core 6 is applied with attractive force toward an attractive portion of the stator core 41. Thus, the moving core 6 starts approaching the attractive portion of the stator core 41, in a condition, in which the valve 7 is biased onto the valve seat 30 of the seat member 4 by resiliency of the coil spring 8.

The moving core 6 moves to the attractive portion of the stator core 41, so that the valve 7 lifts from the valve seat 30 of the seat member 4 downwardly in FIG. 2. Thus, as referred to FIG. 1, the valve port 36 is communicated, so that negative pressure in the intake pipe 13 is introduced into the canister 12. Fuel vapor is removed form the absorbent in the canister 12, and the fuel vapor is introduced into the intake pipe 13 through a vapor passage, so that the fuel vapor is purged. The vapor passage is constructed of a canister 12, the upstream of the fluid introduction passage 15, the inlet port 31 of the solenoid valve 1, the fluid passage 32, the upstream of the volume chamber 33, the filter 9, the downstream of the volume chamber 33, the annular space 34, the valve chamber 35, the valve port 36, the fluid passage 37, the fluid passage 38, the outlet port 39 of the solenoid valve 1, and the downstream of the fluid introduction passage 15.

The mesh sheet 51 of the filter 9 captures foreign matters contained in the fluid flowing to the side of movable components constructed of the moving core 6, the valve 7, and the like. The foreign matters may be particles of absorbent, which is supported in the canister 12, disintegrated due to vibration of the engine. The foreign matters may be debris in the atmosphere intruding into the fuel tank 11 when fuel is fed into the fuel tank 11. Alternatively, the foreign matters may be debris in the atmosphere intruding through a vent hole of the canister 12. The foreign matters contained in the fluid can be restricted from intruding into the sliding portion such as the valve port 36 of the solenoid valve 1 and the solenoid actuator. Therefore, sealing properties between the valve 7 and the valve seat 30 of the seat member 4 can be maintained. In addition, the movable device constructed of the moving core 6 and the valve 7 can be protected from causing disorder.

As referred to FIGS. 2, 4, the flexible sheet-shaped filter 9 is bent to be in a substantially convex shape. Specifically, the cross sectional shape of the filter 9 is bent with respect to the vertical direction, which is perpendicular to the upper-lower sides 52A, 52B of the filter frame 52 when the filter 9 is assembled into the housing 2 of the solenoid valve 1. That is, as referred to FIG. 5, the filter 9 is bent around a straight imaginary line 100 by applying the external force, such that the cross sectional shape of the filter 9 becomes a substantially convex shape protruding to the upstream of the flow direction of the fluid. The opposing surfaces of the recessed portion 59 of the valve case 3 defining the sidewall portion 21 of the fluid passage has the first and second engage grooves 63, 64. The first and second engage grooves 63, 64 slidably engage with the left side 52D and the right side 52C of the filter frame 52 of the filter 9. In this structure, the convex surface of the filter 9 produces high rigidity against external force applied from the upstream of the fluid flow. Thus, the convex surface of the filter 9 can be protected from being recessed to the downstream side with respect to the fluid flow due to fluid pressure applied to the convex surface of the filter 9 from the upstream of the fluid flow.

When the convex surface of the filter 9 receives the fluid pressure from the upstream shown by the arrow in FIG. 4, the filter 9 applies external force to the filter holder 10 vertically in FIG. 4. In this condition, the left side 52D and the right side 52C of the filter frame-52 are pressed onto the bottom surfaces of the first and second engage grooves 63, 64, so that the filter frame 52 makes contact tightly with the bottom surfaces of the first and second engage grooves 63, 64, as the fluid pressure increases.

The left side 52D and the right side 52C of the filter frame 52 can be maintained engaging with the first and second engage grooves 63, 64, even when the convex surface of the filter 9 receives the fluid pressure from the upstream. Thus, sealing properties between the filter holder 10 of the housing 2 and the filter frame 52 can be enhanced.

When the left side 52D and the right side 52C of the filter frame 52 is assembled to the first and second engage grooves 63, 64, the filter 9 is resiliently bent by applying external force to the filter 9 from both the left side 52D and the right side 52C of the filter frame 52. The external force is released after the left side 52D and the right side 52C of the filter frame 52 are assembled to the first and second engage grooves 63, 64, so that the filter frame 52 recovers by the resiliency thereof to extend in the bent direction of the filter frame 52. Thus, the filter frame 52 makes contact closely with the first and second engage grooves 63, 64. In this structure, the gap between the left side 52D of the filter frame 52 and the first engage groove 63 can be substantially eliminated after assembling the filter 9. In addition, the gap between the right side 52C of the filter frame 52 and the second engage groove 64 can be substantially eliminated after assembling the filter 9. Thus, the sealing properties between the filter holder 10 of the housing 2 and the filter frame 52 can be enhanced.

In this structure, the left side 52D and the right side 52C of the filter frame 52 are inserted into the first and second engage grooves 63, 64 with a clearance. Therefore, dimensional tolerance of the first and second engage grooves 63, 64 can be enlarged, compared with a structure, in which the filter frame is press-inserted into the housing. Thus, productivity of the solenoid valve 1 can be enhanced, and manufacturing cost of the solenoid valve 1 can be reduced. In addition, the left side 52D and the right side 52C of the filter frame 52 can be readily assembled to the first and second engage grooves 63, 64. The left side 52D and the right side 52C of the filter frame 52 can be steadily sealed with the first and second engage grooves 63, 64, while the filter 9 is restricted from being jumboized. The filter frame 52 can be readily inserted to the corners of the first and second engage grooves 63, 64, even when the corners of the first and second engage grooves 63, 64 are substantially rectangular. In this structure, the filter 9 is capable of capturing microscopic foreign matters.

(Modification)

The filter 9 of the above embodiment is not limited to be applied to a fuel vapor processing apparatus for a vehicle. The filter 9 can be applied to any other structure of valves such as solenoid flow control valves and solenoid pressure control valves. The fluid is not limited to air and fuel vapor. The fluid may be vapor such as vapor refrigerant, liquid such as water, fuel, oil, and liquid-phase refrigerant, and two-phase fluid. The valve lift may be operated as voltage applied to the coil or electric current conducted to the coil is changed. The filter 9 may be provided to midway through the vent pipe 16 for filtering air flowing into the canister 12. The filter 9 may be provided to midway through a tubular member serving as a fluid passage pipe for filtering fluid passing through the tubular member.

The filter may have a bendable bellows structure. In this case, the bellows filter can be also applied with external force for readily assembling the bellows filter, and for readily sealing the bellows filter with the filter holder.

The filter may be a filter element formed of a filter paper, a fabric material, or the like. The filter may be a filter element formed of a thin mesh sheet having a net-like structure or a honeycomb structure. The filter element may be formed of any materials such as metal or resin. The filter frame may be formed integrally with a bridge portion such as a lattice portion, a cross joint, or a linear portion of any materials such as metal or resin. The filter element may be interposed in multiple sheet-shaped frame members. The filter holder 10 and the passage wall surface of the housing may be individually formed. In this structure, the filter holder 10 may have a substantially rectangular shape such as a rectangular tubular shape, a rectangular annular shape, or a square annular shape, to engage with the filter frame 52. The front shape of the filter frame 52 when being viewed from the upstream of the fluid flow may be a substantially rectangular shape, a trapezoidal shape, and a parallelogram having two parallel opposite sides, for example. These two parallel opposite sides may be respectively inserted to the first and second engage portions 61, 62.

The solenoid valve may be an ON-OFF valve. The solenoid valve may be a normally close valve or a normally open valve. The moving core 6 may be substituted to a movable core such as an armature. A connecting member such as a valve shaft or a plunger may be interposed between the movable core and the valve 7. The first and second engage grooves 63, 64 may be grooves recessed in the wall surface of the fluid passage of the housing 2. The cross sections of the first and second engage grooves of the filter holder 10 may be protruded shapes. The first and second engage grooves may be formed in the bottom surface of the valve case 3 and the top surface of the top plate portion 28 of the seat member 4. In this structure, the upper-lower sides 52A, 52B of the filter frame 52 may have protruded engaged portions.

The first and second filter seat surfaces 65, 66 are not limited to flat or linear surfaces. The first and second filter seat surfaces 65, 66 may be in curved shapes, which are bent to the upstream of the fluid flow, in order to maintain the filter 9 in a bent condition.

At least one of the inner circumferential periphery and the outer circumferential periphery of the sidewall portion 21 of the valve case 3 and at least one of the inner circumferential periphery and the outer circumferential periphery of the top plate portion 28 of the seat member 4 may be screwed, crimped, or fixed using a metallic clip, for example. In this structure, the valve case 3 and the top plate portion 28 preferably interpose an O-ring therebetween.

The cross sectional shape of the filter is not limited to the substantially convex shape. The filter may be sharply bent. The filter may have various protruding cross sectional shapes such as a substantially rectangular bent shape. The filter may be bent for multiple times, so that the cross sectional shape of the filter may have multiple substantially stepwise portions, for example.

The coil spring 8 may be omitted.

Various modifications and alternations may be diversely made to the above embodiments without departing from the spirit of the present invention.

What is claimed is:

1. A filter apparatus comprising:
a tubular member that has an internal space; and
a filter that is accommodated in the internal space of the tubular member when the filter is bent around a straight imaginary line, the filter being adapted to filtering fluid flowing through the internal space of the tubular member,
wherein the filter has a cross section, which is perpendicular to the straight imaginary line, being in a substantially curvature protruding to an upstream with respect to a flow direction of the fluid when the filter is bent around the straight imaginary line,
the filter has a first side and a second side that are opposite to each other with respect to the straight imaginary line,
the tubular member has a first engage portion and a second engage portion,
the first engage portion is adapted to engaging with the first side of the filter, and
the second engage portion is adapted to engaging with the second side of the filter.

2. The filer apparatus according to claim 1, wherein the filter is resiliently bent when the filter is applied with external force from the first side and second side substantially perpendicularly to the straight imaginary line.

3. The filer apparatus according to claim 1,
wherein the filter has a substantially sheet shape, and
the filter is flexible.

4. The filer apparatus according to claim 1, wherein the filter has a frame that has at least two sides, which are substantially in parallel with each other.

5. The filer apparatus according to claim 4,
wherein two of the at least two sides of the frame define the first side and second side of the filter, and
the two of the at least two sides of the frame are respectively inserted to the first engage portion and the second engage portion so that the filter is supported in the tubular member.

6. The filer apparatus according to claim 1, wherein each of the engage portions has an engage groove that substantially linearly extend perpendicularly to the flow direction of the fluid.

7. The filer apparatus according to claim 1, further comprising:
a solenoid valve,
wherein the tubular member defines a housing of the solenoid valve,
the housing has a fluid passage therein, and
the fluid passage accommodates the filter.

8. The filer apparatus according to claim 1,
wherein the straight imaginary line is substantially in parallel with the first side of the filter, and
the straight imaginary line is substantially in parallel with the second side of the filter.

9. The filer apparatus according to claim 8,
wherein the first side of the filter is substantially in parallel with the second side of the filter, and
the first engage portion of the tubular member is substantially in parallel with the second engage portion.

10. A filter apparatus comprising:
a tubular member that has an internal space having a first engage portion and a second engage portion; and
a filter that has a first side and a second side respectively engaging with the first engage portion and the second engage portion of the tubular member when the filter is accommodated in the internal space of the tubular member in a condition, in which the filter is resiliently bent around a straight imaginary line, the straight imaginary line being interposed between the first side and the second side of the filter,
wherein the filter being adapted to filtering fluid flowing through the internal space of the tubular member, and
the filter has a cross section, which is perpendicular to the straight imaginary line, being in a substantially curvature protruding to an upstream with respect to a flow direction of the fluid when the filter is bent around the straight imaginary line.

11. The filer apparatus according to claim 10,
wherein the straight imaginary line is substantially in parallel with the first side of the filter, and
the straight imaginary line is substantially in parallel with the second side of the filter.

12. The filer apparatus according to claim 11,
wherein the first side of the filter is substantially in parallel with the second side of the filter, and
the first engage portion of the tubular member is substantially in parallel with the second engage portion.

13. The filer apparatus according to claim 10,
wherein the first side of the filter and the first engage portion of the tubular member define a clearance therebetween, and
the second side of the filter and the second engage portion of the tubular member define a clearance therebetween.

14. A filter apparatus comprising:
a tubular member that has an internal space having a first engage portion and a second engage portion; and
a filter that has a substantially rectangular shape having a first side and a second side, which are opposite to each other with respect to a straight imaginary line, the first side, the second side, and the straight imaginary line being substantially in parallel with each other, the first side and the second side resiliently engaging respectively with the first engage portion and the second engage portion of the tubular member when the filter is accommodated in the internal space of the tubular member in a condition in which the filter is resiliently bent around the straight imaginary line,
wherein the filter has a cross section, which is perpendicular to the straight imaginary line, being in a substantially curvature protruding perpendicularly to the straight imaginary line when the filter is bent around the straight imaginary line.

15. The filer apparatus according to claim 14,
wherein the first side of the filter and the first engage portion of the tubular member define a clearance therebetween, and
the second side of the filter and the second engage portion of the tubular member define a clearance therebetween.
